(19) United States
(12) Patent Application Publication
(10) Pub. No.: US 2019/0232241 A1
(43) Pub. Date: Aug. 1, 2019

(54) BLENDING APPARATUS FOR MANUFACTURED WOOD PROCESSING

(71) Applicant: LOUISIANA-PACIFIC CORPORATION, NASHVILLE, TN (US)

(72) Inventor: DAVID G. EDWALL, HAYWARD, WI (US)

(21) Appl. No.: 16/177,154

(22) Filed: Oct. 31, 2018

Related U.S. Application Data
(60) Provisional application No. 62/579,182, filed on Oct. 31, 2017.

(51) Int. Cl. B01F 9/06; B27N 1/02

(52) U.S. Cl. CPC B01F 9/06; B01F 2009/0092; B27N 1/0218

(57) ABSTRACT

An improved blending apparatus for blending of wood strands in the manufacture of engineered wood products. The blending process is performed with a rotating blending drum with an internal offset spike/paddle roll. The spike/paddle roll is substantially parallel to the longitudinal axis of the drum, extends for some, all, or substantially all of the length of the drum, may rotate in either direction, and can rotate independently of or in conjunction with the rotation of the drum. The roll has a central cylinder or rod with a number of paddles, spikes, and/or tines, separately or in combinations, extending from the exterior. The paddles, spikes, and/or tines may extend at various angles and directions, including, but not limited to, substantially right angles. The paddles, spikes, and/or tines may be made of any suitable materials, including, and may be made of different materials. The rod may be driven by an external or internal motor or drive, or powered by the rotation of the drum itself.

This application claims priority to and benefit of U.S. Provisional Application No. 62/579,182, filed Oct. 31, 2017, which is incorporated herein by specific reference for all purposes.

### FIELD OF INVENTION

This invention relates to an improved blending apparatus for manufacturing engineered or composite wood products (e.g., OSB, oriented strand board).

### BACKGROUND OF THE INVENTION

An early step in the manufactured wood process is the blending of wood strands with a variety of additives prior to mat formation and pressing. The blending typically occurs in a blending drum that rotates. However, a continuing problem in prior art blending processes is an uneven distribution and application of additives to the wood strands as they pass through the blending drum, resulting in inconsistent additive coverage of the wood strands. In addition, wood strands can vary in size, and strands that are wider or longer can curl or fold, also leading to inconsistent or spotty additive coverage.

### BRIEF DESCRIPTION OF THE DRAWINGS

FIG. 1 shows a side view of an apparatus in accordance with an embodiment of the present invention.

FIG. 2 shows an end view of the apparatus of FIG. 1.

### DETAILED DESCRIPTION OF EXEMPLARY EMBODIMENTS

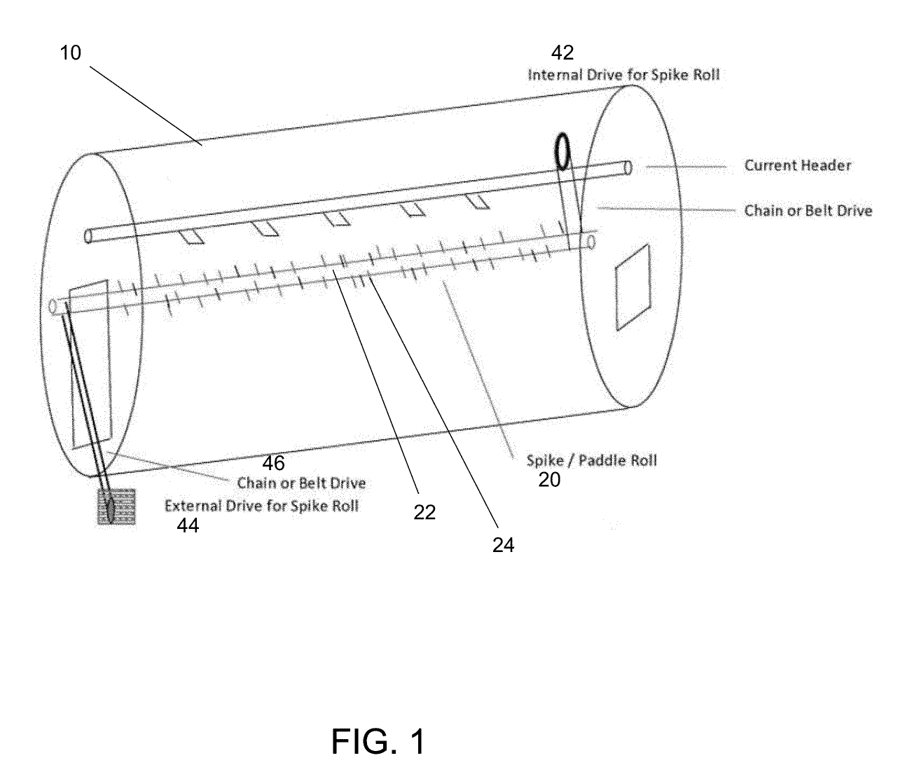

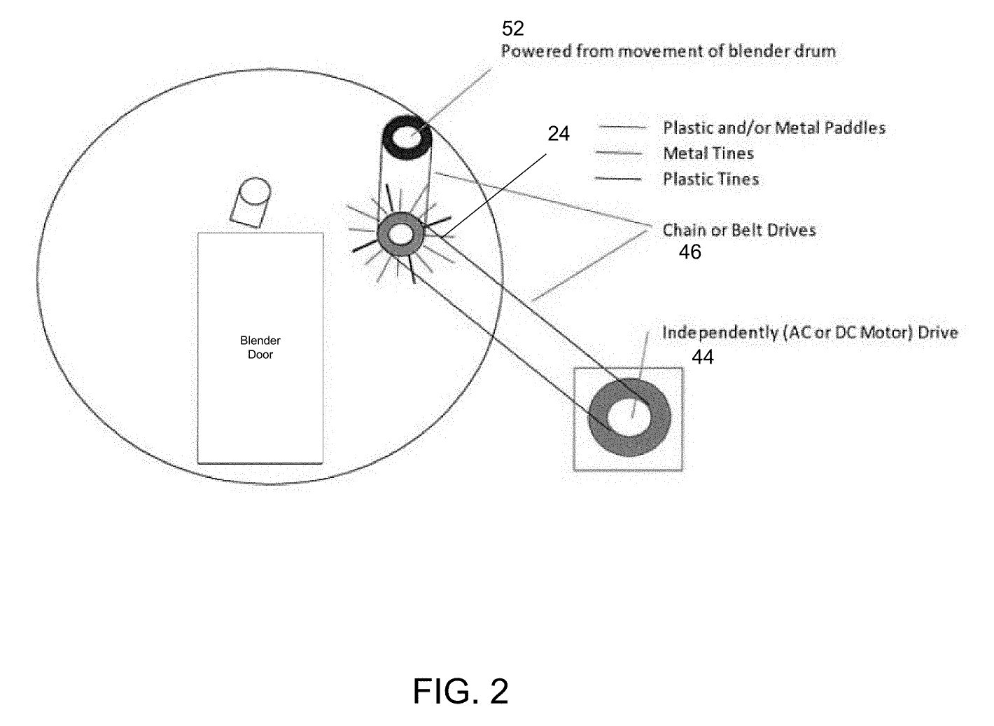

In various exemplary embodiments, the present invention comprises an improved blending apparatus that overcomes the inconsistent and partial additive coverage and application to wood strands in the blending process. As seen in FIGS. 1-2, the improved blending apparatus comprises a rotating blending drum 10 with an offset spike/paddle roll 20. The spike/paddle roll 20 is substantially parallel to the longitudinal axis of the drum, and extends for some, all, or substantially all of the length of the drum. The spike/paddle roll 20 can rotate in either direction, and can rotate independently of or in conjunction with the rotation of the drum 10.

In several embodiments, the roll comprises a cylinder or rod 22, with a number of paddles, spikes, and/or tines 24, separately or in combinations, extending from the exterior. The paddles, spikes, and/or tines 24 may extend at various angles and directions, including, but not limited to, substantially right angles. The paddles, spikes, and/or tines may be made of any suitable materials, including, but not limited to, plastic or metal, or combinations thereof.

In various embodiments, the rotation of the roll 20 may be driven by an independent motor or drive (AD or DC), internal or external 44 with respect to the drum, directly or indirectly through one or more chains or belts 46. The roll also may be driven by a chain or belt connected to a wheel or gear 52 driven by movement of the blender drum. For example, the wheel or gear 52 may be in contact with the interior face of the blender drum, and thus cause rotation of the roll in conjunction with rotation of the drum. A combination of different wheels or gears can be implemented to cause the roll to rotate in the same direction or reverse direction as the drum, and at different speeds.

The roll 20 promotes and enhances turbulence and mixing in the blending drum, leading to a more consistent and even flow of the wood furnish through the blender, promoting more consistent and even application of the additives. Additives include, but are not limited to, a sizing agent (e.g., wax, emulsion or slack wax), a resin (e.g., pMDI, MUF, MUPF, or PF), and/or a preservative (e.g., zinc borate).

An application of the improved blending apparatus is described in context of the manufacturing of an engineered wood composite as follows:

a. Woods strands or plies are dried and stored.

b. Designated strands or plies (e.g., bottom, core, top layers) are blended with applicable additives in the improved blending apparatus described above, achieving a more consistent and even application of additives to the wood strands or plies.

c. Three or more layers of treated strands or plies (typically with moisture content of 2 to 10%) are formed as a mat, each layer being oriented.

d. Strands or plies may or may not be covered with a fine layer of wood particles. The fine layer typically weighs between 0.05 to 0.40 lbs/cubic foot, and may be treated with a sizing agent (e.g., wax, emulsion or slack wax), a resin (e.g., pMDI, MUF, MUPF, or PF), and/or a preservative (e.g., zinc borate).

e. The mat is pressed in a high pressure, high temperature press to consolidate the mat into a board or panel of desired or targeted thickness.

f. After a period of time (typically not more than 14 days), the board/panel may or may not be processed through a sander (i.e., to remove some imperfections on a top or bottom surface, reduce thickness variations in the panel, or to machine a tongue and groove for installation).

g. The panel usually undergoes additional finishing (e.g., panels cut to size; an edge seal or primer is applied to the panel, typically in a unit or stack of panels, by automatic or hand sprayers; and final packaging) to produce the finished product.

The present invention thus provides an improved, higher quality OSB or engineered/manufactured wood composite panel through the improved blending process introduced in-line, with an increase in performance and efficiency and reduction in cost. Further, the present invention promotes a smoother flow of the wood furnish through the blender, and assists with the reduction of build-up on the blender walls, both of which reduce down-time, increase performance and efficiency of the blender operation, and reduces costs.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. An improved blending apparatus, comprising:
a rotating blending drum with an exterior and an interior and a longitudinal axis;
an internal offset spike/paddle roll extending substantially parallel to the longitudinal axis, with a plurality of paddles, spikes, and/or tines.

2. The apparatus of claim 1, wherein the roll comprises a central cylinder or rod, with the plurality a plurality of paddles, spikes, and/or tines extending therefrom.

3. The apparatus of claim 1, where the roll rotates independently of the drum rotation.

4. The apparatus of claim 1, wherein the roll rotates in conjunction with the drum rotation.

5. A method of treating wood strands or plies in the manufacture of an engineered wood composite, comprising the steps of:
providing a rotating blending drum with an exterior and an interior and a longitudinal axis, and an internal offset spike/paddle roll extending substantially parallel to the longitudinal axis, with a plurality of paddles, spikes, and/or tines;
loading the blending drum with wood strands or plies;
applying additives to the wood strands or plies; and
blending the wood strands or plies with the additives through rotation of the blending drum and rotation of the roll;
wherein the roll is configured to provide a more consistent and even application of additives to the wood strands or plies.
